(19) United States
(12) Patent Application Publication
(10) Pub. No.: US 2026/0129728 A1
(43) Pub. Date: May 7, 2026

(54) INTEGRATED LIGHT-EMITTING DIODE PACKAGE DEVICE

(71) Applicant: NBIAS, Daejeon (KR)

(72) Inventors: Eun-Sung Kim, Sejong-si (KR); Jae Chul Lee, Daejeon (KR); Chang Gil Lee, Daejeon (KR)

(21) Appl. No.: 19/377,849

(22) Filed: Nov. 3, 2025

(30) Foreign Application Priority Data
Nov. 5, 2024 (KR) 10-2024-0155369
Mar. 14, 2025 (KR) 10-2025-0033523

(51) Int. Cl. H05B 45/30

(52) U.S. Cl. CPC H05B 45/30

(57) ABSTRACT

An integrated light-emitting diode (LED) package device includes: a power supply unit that supplies power supplied from an external power source; a communication unit that transmits LED bin information to an external controller and receives an LED drive signal from the external controller; an LED; and a driver that includes a storage unit that stores the LED bin information and a control unit that controls voltage or current applied to the LED according to a control signal received from the external controller. The LED receives the controlled voltage or current from the control unit and emits light under preset conditions.

### CROSS-REFERENCE TO RELATED APPLICATION

This application claims the benefit of and priority to Korean Patent Application No. 10-2024-0155369, filed on Nov. 5, 2024, and Korean Patent Application No. 10-2025-0033523, filed on Mar. 14, 2025. The entire disclosures of these applications are hereby incorporated herein by reference in its entirety.

### TECHNICAL FIELD

The present disclosure relates to an integrated light-emitting diode (LED) package device, and more particularly, to an integrated LED package device in which an LED, a driver for controlling the LED, and a memory storing LED bin information are integrated into a single chip.

### BACKGROUND

Light-emitting diodes (LEDs) are efficient light-emitting elements widely used in electronic devices and are utilized in diverse fields, including lighting, displays, and traffic lights. While the LEDs offer advantages such as low power consumption and long lifespan, the required current and voltage values may vary depending on the characteristics of each LED. Consequently, systems using multiple LEDs require separate current settings that take into account the characteristics of each LED, which presents numerous design and implementation challenges.

In particular, when connecting multiple LEDs to the same circuit or trying to control multiple LEDs within the same package, a problem arises in that the appropriate current value should be individually set for each LED because each LED has different unique characteristics (e.g., bin information).

The “bin information” refers to data that determines the optimal current, voltage, color, brightness, or the like for each LED to emit light. However, conventionally, because the bin information for each LED should be managed separately and current control should be performed based on this, individual control circuits and settings are required for each LED, leading to complex design and extensive wiring.

Furthermore, when the bin information for each LED is stored in a separate external memory or control device, communication with the external device or additional wiring is required to appropriately control the current according to the information, which increases the size and complexity of the system and requires additional cost and time to implement optimized control. Therefore, existing LED systems have encountered problems such as managing bin information for each LED and complex circuit configuration for individual control, increased wiring, and decreased system efficiency.

### SUMMARY

The present disclosure has been devised to solve the above-described problem, and an object of the present disclosure is to provide a single-chip type light-emitting diode (LED) package device in which a memory in which bin information is pre-stored and a control circuit are integrated.

In addition, another object of the present disclosure is to provide an integrated LED package device that can simply configure an LED system without additional circuit design or complex wiring work.

Objects of the present disclosure are not limited to the objects mentioned above, and other objects not mentioned should be clearly understood by those having ordinary skill in the art from the description below.

In order to achieve the above-described objects, according to one embodiment of the present disclosure, an integrated LED package device includes: a power supply unit that supplies power supplied from an external power source; a communication unit that transmits LED bin information to an external controller and receives an LED drive signal from the external controller; an LED; and a driver that includes a storage unit that stores the LED bin information and a control unit that controls voltage or current applied to the LED according to a control signal received from the external controller. The LED receives the controlled voltage or current from the control unit and emits light under preset conditions.

According to one embodiment of the present disclosure, the communication unit may be selectively switched to a Universal Asynchronous Receiver/Transmitter (UART) communication method or a Controller Area Network (CAN) communication method via a configuration pin (CNF PIN).

According to one embodiment of the present disclosure, the storage unit may store LED bin information including at least one of light quantity, voltage, or color information of the LED.

According to one embodiment of the present disclosure, the control unit may control the voltage or current applied to the LED according to the LED bin information.

According to one embodiment of the present disclosure, the storage unit may store a unique address assigned by the external controller.

According to one embodiment of the present disclosure, the communication unit may transmit the LED bin information stored in the storage unit to the external controller and receive a control signal from the external controller to drive the LED under preset conditions, and the control unit may determine the voltage or current applied to the LED according to the control signal.

According to the integrated LED package device described above, the current is automatically controlled through a memory in which the bin information of each LED is pre-stored, so that the optimal current required for each LED can be automatically supplied without separate manual settings.

In addition, the existing complex process of individually setting the output current supplied to each LED becomes unnecessary, and the effect of efficiently controlling the entire system can be achieved.

In addition, since the bin information of the LED, the driver that controls the bin information, and the LED are integrated into a single chip, additional external wiring or circuits can be omitted, minimizing the size and volume of the entire system, enabling an efficient system configuration even in a smaller space.

### BRIEF DESCRIPTION OF THE DRAWINGS

FIG. 1 is a functional block diagram illustrating an integrated LED package device according to one embodiment of the present disclosure.

FIG. 2 is a diagram illustrating a plurality of integrated LED package devices connected to one external controller according to one embodiment of the present disclosure.

FIG. 3 is a diagram for explaining a method of controlling a plurality of integrated LED package devices with one external controller according to one embodiment of the present disclosure.

FIG. 4 is a flowchart illustrating a process in which an external controller controls a plurality of respective integrated LED package devices according to one embodiment of the present disclosure.

### DETAILED DESCRIPTION

Hereinafter, embodiments of the present disclosure are described in detail with reference to the attached drawings. The advantages and features of the present disclosure, and methods for achieving them, should become clearer with reference to embodiments described in detail below together with the attached drawings. However, the technical idea of the present disclosure is not limited to the following embodiments and may be implemented in various different forms. The following embodiments are provided only to complete the technical idea of the present disclosure and to fully inform those having ordinary skill in the art of the present disclosure of the scope of the present disclosure, and the technical idea of the present disclosure is defined only by the scope of the claims.

When assigning reference numerals to components in each drawing, it should be noted that identical components are assigned the same numerals whenever possible, even if they appear on different drawings. Furthermore, when describing the present disclosure, when a detailed description of a related known configuration or function is deemed likely to obscure the gist of the present disclosure, such detailed description has been omitted.

Unless otherwise defined, all terms (including technical and scientific terms) used herein may be used in the same sense as commonly understood by those of ordinary skill in the art to which this disclosure pertains. Furthermore, terms defined in commonly used dictionaries are not to be interpreted ideally or excessively unless explicitly and specifically defined otherwise. The terminology used herein is for the purpose of describing embodiments and is not intended to limit the disclosure. In this specification, singular forms also include plural forms, unless specifically stated otherwise.

Additionally, terms such as first, second, A, B, (a), (b), or the like may be used to describe components of the present disclosure. These terms are only intended to distinguish the components from other components, and the nature, order, or sequence of the components are not limited by the terms. When a component is described as being “connected”, “coupled”, or “joined” to another component, it should be understood that the component may be directly connected or joined to the other component, but another component may also be “connected”, “coupled”, or “joined” between each component.

As used herein, the terms “comprise” and/or “comprising” do not exclude the presence or addition of one or more other components, steps, operations, and/or elements. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, various embodiments of the present disclosure are described in detail with reference to the attached drawings.

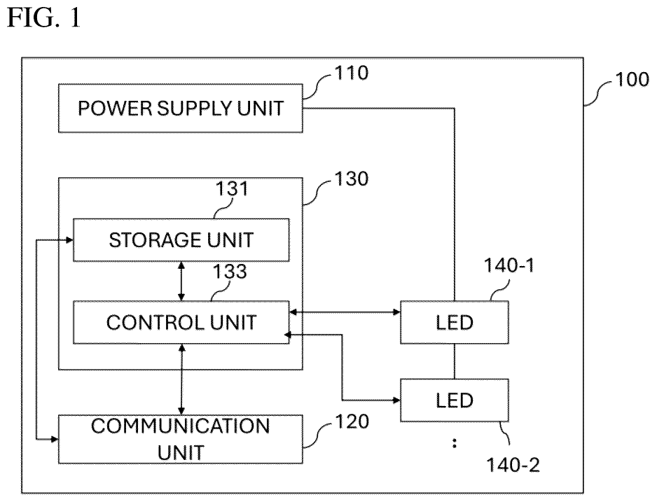

FIG. 1 is a functional block diagram illustrating an integrated light-emitting diode (LED) package device 100 according to one embodiment of the present disclosure.

The integrated LED package device 100 according to one embodiment of the present disclosure includes a power supply unit 110, a communication unit 120, a driver 130, and at least one LED 140-1, 140-2, . . . and 140-n (not shown). Only components related to embodiment of the present disclosure are illustrated in FIG. 1, and other components may be included in addition to the components illustrated in FIG. 1.

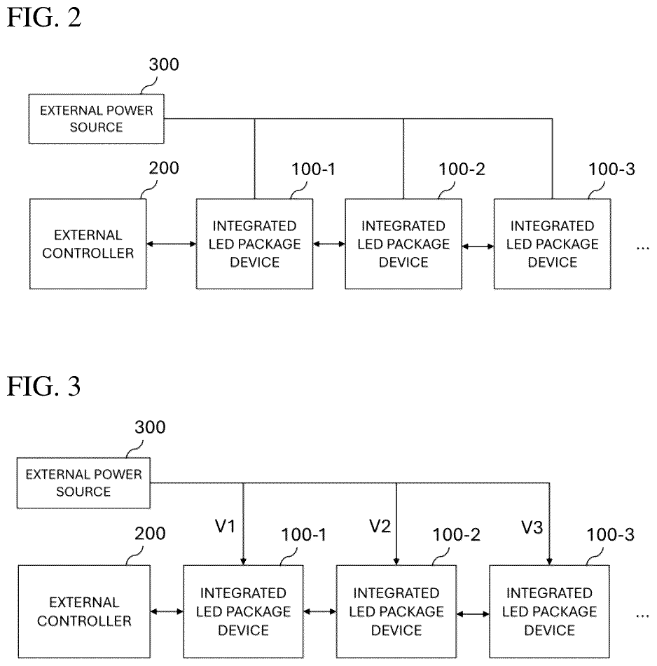

The power supply unit 110 supplies power supplied from an external power source 300 (see FIG. 2). The power supply unit 110 according to one embodiment of the present disclosure may include a configuration for changing the voltage supplied from the external power source into a voltage suitable for the LED 140 and other components. As used herein, LDE(s) 140 may generally be referencing at least one of LED 140-1, 140-2, . . . or 140-n. Although two LEDs 140 are illustrated in FIG. 1, the number of the integrated LED package devices is not limited thereto.

Additionally, it may include components for supplying stable power to each component through voltage regulation and current limiting and protecting the integrated LED package device 100 from overvoltage, overcurrent, and overheating.

The communication unit 120 transmits bin information of the LED to an external controller and receives an LED drive signal from the external controller. The bin information and LED drive signal transmitted and received through the communication unit 120 is described in detail below.

According to one embodiment of the present disclosure, the communication unit 120 may selectively switch between a Universal Asynchronous Receiver/Transmitter (UART) communication method and a Controller Area Network (CAN) communication method via a configuration pin (CNF PIN). This allows efficient data exchange with the external controller. The CNF PIN may be used to set the operating mode of a chip. For example, by applying a specific voltage or using pull-up/pull-down resistors via the CNF PIN, the chip (e.g., the communication unit 120) may operate in either UART communication method or CAN communication method.

When the CNF PIN is in a high state, the communication unit 120 is set to UART mode. The UART mode is a communication method that uses asynchronous serial communication. When the communication unit 120 is set to the UART mode, the communication unit 120 may transmit and receive data through settings such as baud rate, parity bit, and flow control. When the CNF PIN is in the low state, the communication unit 120 is set to the CAN mode. The CAN mode is a high-speed serial communication method.

As described above, since the communication method can be changed using the CNF PIN, the UART and CAN communication methods may be selected according to the system requirements, which can achieve the effect of enabling efficient operation in various environments.

The driver 130 includes a storage unit 131 that stores bin information and a control unit 133 that controls the voltage or current applied to the LED according to a control signal received from the sub-controller.

The bin information stored in the storage unit 131 may include at least one of light quantity, voltage, and color information of the LED 140. The light quantity refers to the amount of light emitted from the LED 140, and voltage refers to the voltage required for the LED 140 to operate normally. In addition, the color information refers to color information of the LED 140 according to Red, Green, Blue (RGB) or other color spaces.

The control unit 133 applies different voltages or currents to the LED 140 according to the bin information, so that the LED 140 emits light under preset conditions. The control unit 133 according to one embodiment of the present disclosure may control the voltage or current applied to the LED 140 through Pulse Width Modulation (PWM) control. In addition, a protection circuit for protecting the LED 140 from overcurrent or overvoltage may be further included.

The LED 140 receives a controlled voltage or current from the control unit 133 and emits light under preset conditions. The preset conditions may include one of a specific light quantity, a specific color temperature, and a specific light emission timing.

According to the integrated LED package device 100 described above, the plurality of LEDs 140 having different bin values can be made to emit light under the same conditions with one external controller, thereby achieving the effect of eliminating the need for a plurality of external controllers for individually controlling the LEDs 140.

In addition, the effect of enabling individual voltage or current control can be achieved without adding hardware configurations such as a resistor to control the voltage or current applied to each LED 140 to make LEDs 140 with different bin values light up under the same conditions.

FIG. 2 is a diagram illustrating a plurality of integrated LED package devices connected to one external controller according to one embodiment of the present disclosure.

An external controller 200 generates a control signal to cause the LEDs 140 included in the integrated LED package device 100 to emit light under preset conditions. For example, the external controller may be implemented as a Microcontroller Unit (MCU).

An external controller 200 according to one embodiment of the present disclosure may receive bin information of LEDs 140 from integrated LED package devices 100-1, 100-2, 100-3 . . . and 100-n (not shown), and generate different control signals for each LED 140 according to the bin information. The control signal may be a voltage or current control signal applied to the LED 140 to cause the LED 140 to emit light under preset conditions. As used herein, integrated LED package device(s) 100 may generally be referencing at least one of an integrated LED package device 100-1, 100-2, 100-3 . . . or 100-n. Although three integrated LED package devices 100 are illustrated in FIGS. 2 and 3, the number of the integrated LED package devices is not limited thereto.

The external controller 200 may assign addresses to the plurality of integrated LED package devices 100 connected via the CAN or UART, and may receive bin information from the integrated LED package devices 100 through the assigned addresses or transmit LED 140 control signals to each of the integrated LED package devices 100.

According to the above-described connection structure, the plurality of integrated LED package devices 100-1, 100-2, . . . , and 100-n may be controlled by a single external controller 200, thereby achieving the effect of simplifying the wiring structure and minimizing the volume.

FIG. 3 is a diagram for explaining a method of controlling the plurality of integrated LED package devices 100-1, 100-2, . . . , and 100-n with one external controller 200 according to one embodiment of the present disclosure.

The bin information of the LEDs included in each of the integrated LED package devices 100-1, 100-2, . . . , and 100-n illustrated in FIG. 3 may be different from each other. In other words, since each LED has different color, brightness, and voltage characteristics, in order to drive them equally, a driving current or voltage suitable for the characteristics of each LED should be applied.

When the same voltage or current is applied regardless of the LED blank characteristics, a voltage or current exceeding the driving voltage or driving current may be applied, causing the LED to overheat or shorten its lifespan, or causing each LED to emit light with a different color or amount of light.

Accordingly, the external controller 200 according to one embodiment of the present disclosure receives the bin information of LEDs included in integrated LED package devices 100-1, 100-2, . . . , and 100-n through the UART or CAN communication.

The external controller 200 generates a control signal for each LED package device to cause the LEDs included in the integrated LED package devices 100-1, 100-2, . . . , and 100-n to emit light with the same characteristics.

For example, as illustrated in FIG. 3, a control signal may be generated to apply a voltage V1 to the LED of a first integrated LED package device 100-1, a voltage V2 to the LED of a second integrated LED package device 100-2, and a voltage V3 to the LED of a third integrated LED package device 100-3. The magnitudes or value of V1, V2, and V3 may be different from each other.

The driver 130 of the integrated LED package device 100 that receives the control signal from the external controller 200 may control the integrated LED package device so that a voltage corresponding to the control signal is applied to the LED 140.

In FIG. 3, a control signal is generated to apply different voltages to the LEDs 140 included in each integrated LED package device 100, but the specific control content (e.g., the specific control details) is not limited thereto. For example, control content regarding the timing of applying different magnitudes of current or power may be included.

The external controller 200 can control the integrated LED package devices 100-1, 100-2, . . . , and 100-n in a power saving mode (PSM) to maximize power efficiency. The power saving mode according to one embodiment of the present disclosure refers to a mode for minimizing power consumed by the integrated LED package device.

The external controller 200 may switch the integrated LED package devices 100-1, 100-2, . . . , and 100-n to the power saving mode when the standby time of the integrated LED package devices 100-1, 100-2, . . . , and 100-n exceeds a preset time.

To switch the integrated LED package devices 100-1, 100-2, . . . , and 100-n to the power saving mode, the external controller 200 may transmit a broadcast signal to each of the integrated LED package devices 100-1, 100-2, . . . , and 100-n.

The broadcast signal is a signal transmitted by the external controller 200 to all integrated LED package devices 100-1, 100-2, . . . , and 100-n connected via the communication interface.

The integrated LED package devices 100-1, 100-2, . . . , and 100-n that receive the broadcast signal from the external controller 200 are switched to the power saving mode. In the power saving mode, the PWM output of the integrated LED package devices 100-1, 100-2, . . . , and 100-n is disabled and the system clock is switched to a low frequency mode.

Therefore, the power consumption through PWM can be minimized without requiring brightness control or color adjustment of the LED, and the basic operating speed of the integrated LED package devices 100-1, 100-2, . . . , and 100-n can be lowered to prevent unnecessary power consumption. For example, in the power saving mode, the integrated LED package devices 100-1, 100-2, . . . , and 100-n consume only a minimum current of about 0.3 mA.

The external controller 200 transmits a wake-up signal to switch the integrated LED package devices 100-1, 100-2, . . . , and 100-n from the power saving mode to a normal mode. For example, the wake-up signal may be a Break Low signal of 150 us or more. The integrated LED package devices 100-1, 100-2, . . . , and 100-n that receive the wake-up signal switch from the power saving mode to the normal mode, and the PWM output and the system clock are normalized to their original states.

The power saving mode described above allows for minimizing power consumption in the integrated LED package devices 100-1, 100-2, . . . , and 100-n and maximizing system efficiency.

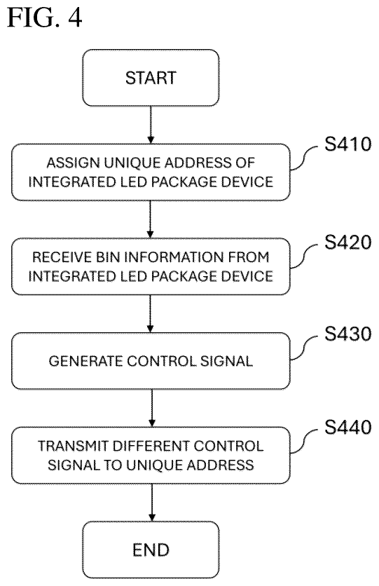

FIG. 4 is a flowchart illustrating a process in which the external controller controls the plurality of respective integrated LED package devices according to one embodiment of the present disclosure.

In order for the external controller 200 to independently control each of the plurality of integrated LED package devices 100-1, 100-2, . . . , and 100-n, a unique address (e.g., a specific and no duplicates existing address) should be assigned to each of the integrated LED package devices 100-1, 100-2, . . . , and 100-n. Through the unique address, the external controller 200 may accurately identify each of the integrated LED package devices 100-1, 100-2, . . . , and 100-n and generate and transmit a control signal corresponding to the bin information.

The external controller 200 assigns a unique address to each of the plurality of integrated LED package devices 100-1, 100-2, . . . , and 100-n (S410).

The external controller 200 according to one embodiment of the present disclosure may assign different unique addresses to the integrated LED package devices 100-1, 100-2, . . . , and 100-n via the CAN or UART. The assigned unique addresses are stored in the storage unit of the integrated LED package devices 100-1, 100-2, . . . , and 100-n.

Alternatively, the unique address may be pre-stored in the storage unit of the integrated LED package devices 100-1, 100-2, . . . , and 100-n. In this case, when the external controller 200 transmits an address allocation request signal to the integrated LED package devices 100-1, 100-2, . . . , and 100-n, the integrated LED package devices 100-1, 100-2, . . . , and 100-n transmit the unique address to the external controller 200.

Next, the external controller 200 receives LED bin information from the integrated LED package device (S420).

Specifically, the external controller 200 transmits a bin information request signal by specifying a unique address of a specific integrated LED package device in the ID (identification) field of the CAN or UART message.

The integrated LED package device 100-1, 100-2, . . . , and 100-n transmits bin information to the external controller 200 when the unique address specified in the ID field of the message matches the unique address stored in the memory.

The external controller 200 that receives bin information from integrated LED package devices 100-1, 100-2, . . . , and 100-n generates a control signal for driving the LED under preset conditions by using characteristics of the LED, such as brightness, color, and voltage drop (S430). The control signal may include at least one of a control signal for driving voltage, driving current, or lighting timing of the LED.

The external controller 200 transmits the control signal generated for each integrated LED package device 100-1, 100-2, . . . , and 100-n together with a unique address to the integrated LED package devices 100-1, 100-2, . . . , and 100-n (S440).

The control unit of the integrated LED package device 100-1, 100-2, . . . , and 100-n determines the voltage or current applied to the LED using the control signal received from an external controller 200.

According to the above-described integrated LED package device control method, the current is automatically controlled through the memory in which the bin information of each LED is pre-stored, so that the optimal current required for each LED can be automatically supplied without separate manual settings.

In addition, the existing complex process of individually setting the output current supplied to each LED becomes unnecessary, and the effect of efficiently controlling the entire system can be achieved.

In addition, since the bin information of the LED, the driver that controls the bin information, and the LED are integrated into a single chip, additional external wiring or circuits can be omitted, minimizing the size and volume of the entire system, enabling an efficient system configuration even in a smaller space.

Although all components constituting embodiments of the present disclosure have been described as being combined or operating in combination as one, the technical concept of the present disclosure is not necessarily limited to such embodiments. In other words, within the scope of the present disclosure, all of the components may be selectively combined and operated one or more times.

Although embodiments of the present disclosure have been described with reference to the attached drawings, those having ordinary skill in the art should appreciate that the present disclosure can be implemented in other specific forms without changing the technical concepts or essential features thereof. Therefore, it should be understood that embodiments described above are illustrative in all respects and not restrictive. The scope of protection of the present disclosure should be interpreted by the claims below, and all technical ideas within a scope equivalent thereto should be interpreted as being included within the scope of the technical ideas defined by the present disclosure.

What is claimed is:

1. An integrated light-emitting diode (LED) package device comprising:
a power supply unit that supplies power supplied from an external power source;
a communication unit that transmits LED bin information to an external controller and receives an LED drive signal from the external controller;
an LED; and
a driver that includes a storage unit that stores the LED bin information and a control unit that controls voltage or current applied to the LED according to a control signal received from the external controller,
wherein the LED receives the controlled voltage or current from the control unit and emits light under preset conditions.

2. The integrated LED package device of claim 1, wherein the communication unit is selectively switched to a Universal Asynchronous Receiver/Transmitter (UART) communication method or a Controller Area Network (CAN) communication method via a configuration pin (CNF PIN).

3. The integrated LED package device of claim 1, wherein the storage unit stores the LED bin information including at least one of light quantity, voltage, or color information of the LED.

4. The integrated LED package device of claim 1, wherein the control unit controls the voltage or current applied to the LED according to the LED bin information.

5. The integrated LED package device of claim 1, wherein the storage unit stores a unique address assigned by the external controller.

6. The integrated LED package device of claim 1, wherein the communication unit transmits the LED bin information stored in the storage unit to the external controller and receives the control signal from the external controller to drive the LED under preset conditions, and
the control unit stores a unique address assigned by the external controller that determines the voltage or current applied to the LED according to the control signal.
